(19) United States
(12) Patent Application Publication
(10) Pub. No.: US 2009/0187867 A1
(43) Pub. Date: Jul. 23, 2009

(54) Techniques for Verifying Error Detection of a Design Rule Checking Runset

(76) Inventor: Jay A. Lawrence, Rochester, MN (US)

Correspondence Address: IBM CORPORATION, 3605 HIGHWAY 52 NORTH, DEPT 917, ROCHESTER, MN, 55901-7829, US

(21) Appl. No.: 12/017,524

(22) Filed: Jan. 22, 2008

(51) Int. Cl. G06F 17/50

(52) U.S. Cl. 716/4

(57) ABSTRACT

A technique for verifying error detection of a design rule checking runset includes assigning first shapes for a first layer of an integrated circuit design to a first cell and assigning second shapes for a second layer of the integrated circuit design to a second cell. Design rule checking is then performed on the first and second cells. Whether the design rule checking runset is functioning properly is then determined based on whether an error is detected in the design rule checking of the first and second cells.

### BACKGROUND

1. Field

This disclosure relates generally to a design rule checking runset and, more specifically to techniques for verifying error detection of a design rule checking runset.

2. Related Art

The debugging of integrated circuit (chip) designs may be accomplished through a testing process that involves extensive runs of computer models of a target implementation. Finding and correcting errors before implementing a chip design in silicon can substantially reduce correction costs. Unfortunately, a complex chip may require millions of tests to fully verify the chip is properly functioning. To reduce verification time, researchers have attempted to create design verification approaches that, while limited in scope, adequately test a chip. A popular design verification approach subdivides the verification problem by creating separate design verification tools for checking logical functions of a design, timing of the design, design rules, etc. Design rules have been created to ensure that a designed chip operates in a desired manner. For example, design rule checking (DRC) runsets have been implemented to verify shapes and sizes of various circuit components that are diffused in, deposited on, or etched on a semiconductor wafer. DRC runsets have also been implemented to verify that a location of a shape with respect to other shapes does not violate design rules.

A typical DRC runset usually includes several hundred individual design rule checks. When developing a DRC runset for a semiconductor process, a number of layout testcases have usually been implemented to verify functionality and accuracy of the DRC runset. In general, the DRC runset is created based on layout design rules for a particular semiconductor process. A DRC runset and an associated testcase may be automatically or manually created. Ideally, testcases contain various shapes (test structures) that represent a failing or passing condition for each rule specified in a semiconductor process. A conventional generation and verification program known as Shapediff™, available from IBM Corporation (see U.S. Pat. No. 6,063,132 (hereinafter the '132 patent)), may be utilized in conjunction with various testcases to ensure that a DRC runset is operating properly. In brief, Shapediff™ summarizes execution results of a DRC runset. In general, Shapediff™ is run for each process type and testcases are created for each variation of a process (for example, first testcases may be created for a process that employs three metal levels and second testcases may be created for a process that employs four metal levels). Traditionally, testcases (shapes) for different mask levels of a chip have been included within a single cell. In a typical implementation, each shape is described in a graphics display system (GDS) language. Shapes may be manually created by a designer (or automatically created by code) that evaluates design rules in an associated design rules manual.

As is disclosed in U.S. Pat. No. 6,732,338 (hereinafter the '338 patent), testcases may be organized in a single library with a plurality of root cells. In this case, one of the root cells is utilized for checking rules pertaining to front-end-of-line (FEOL) and multiple of the root cells may be utilized for checking design specific options, including back-end-of-line (BEOL) metal stack options. As is disclosed in the '338 patent, testcases of the root cells are each run separately, and represent complete testing of FEOL rules, and one of a combination of BEOL metal stack options. Shapes may be included in a test file that is organized in rows of shapes on an x-y plane. In a typical implementation, each row contains all shapes for a design rule. The number of shapes per rule vary, for example, between two to approximately twelve, although there is no limit on the number of shapes per row. Usually, the rows of shapes are placed along the y-axis in an order that parallels the design rule sequencing in the design rule manual that defines a fabrication process. Shapes are usually placed on both sides of the y-axis and are usually based on layout structures. For example, shapes located on a x>0 side of the y-axis are intended to pass (produce no error shape), and shapes located on a x<0 side of the y-axis are intended to fail (produce error shapes). In general, Shapediff™ is designed to track intentional fails and passes, as well as unintentional fails and passes.

As noted above, Shapediff™ is designed to verify that a DRC runset is detecting design rule errors correctly. Shapediff™ is also designed to provide output information that can be used to modify a DRC runset, when the DRC runset is not detecting all error conditions correctly or is incorrectly detecting error conditions. Typically, errors are categorized into five categories: intentional fail, intentional pass, unintentional fail, unintentional pass, and missing boundary shape. In general, a DRC runset may be modified in response to: intentional fails that pass, intentional passes that fail, unintentional fails, unintentional passes, and missing boundary conditions.

With reference to FIG. 1, a conventional approach 100 for verifying error detection of a DRC runset 104 has provided flat regression testcases 102 as input to the DRC runset 104. The testcases 102 have included a number of shapes (associated with various layers of an integrated circuit design) grouped in a single cell. An output of the DRC runset 104 is provided to a Shapediff™ program 106, which is configured to verify that the DRC runset 104 is detecting design rule errors correctly. The Shapediff™ program 106 provides output information (flat errata) 108 that can be used to modify the DRC runset 104.

### SUMMARY

According to one aspect of the present disclosure, a technique for verifying error detection of a design rule checking runset includes assigning first shapes for a first layer, of an integrated circuit design, to a first cell and assigning second shapes for a second layer, of the integrated circuit design, to a second cell. Design rule checking is then performed on the first and second cells. Whether the design rule checking runset is functioning properly is then determined based on whether an error is detected in the design rule checking of the first and second cells.

According to another aspect of the present disclosure, a design rule checking runset encoded on a computer-readable storage medium includes first, second, third, and fourth code. The first code is configured to assign first shapes for a first layer (of an integrated circuit design) to a first cell. The second code is configured to assign second shapes for a second layer (of the integrated circuit design) to a second cell. The third code is configured to perform design rule checking on the first and second cells. The fourth code is configured to determine whether the design rule checking runset is functioning properly based on whether an error is detected in the design rule checking of the first and second cells.

According to another aspect of the present disclosure, a technique for verifying error detection of a design rule checking runset assigns first shapes for a first layer, of an integrated circuit design, to a first cell. Second shapes for a second layer, of the integrated circuit design, are assigned to a second cell. The first and second shapes are also assigned to a third cell. Design rule checking is performed on the first and second cells. Design rule checking is also performed on the third cell. Whether the design rule checking runset is functioning properly is determined based on whether an error is detected in the design rule checking of the first and second cells or the third cell.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 is a block diagram of a conventional approach for verifying error detection of a design rule checking (DRC) runset using flat regression testcases (all shapes are located in a single cell).

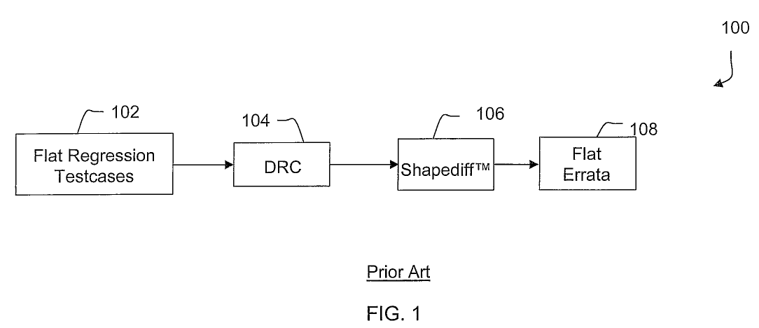

FIG. 2 is a block diagram of an approach for verifying error detection of a DRC runset that uses flat regression testcases and nested regression testcases (shapes for one or more different layers are located in different cells), according to various aspects of the present disclosure.

FIG. 3 is a block diagram of an approach for verifying error detection of a DRC runset that identifies shapes (associated with different layers in an integrated circuit design) in flat regression testcases and separates the shapes into multiple cells, where each of the multiple cells is associated with one or more different layers of the integrated circuit design, according to the present disclosure.

FIG. 4 is a flowchart of a process for verifying error detection of a DRC runset, according to the present disclosure.

FIG. 5 is an example computer system that may be configured to execute the process of FIG. 4.

### DETAILED DESCRIPTION

As will be appreciated by one of ordinary skill in the art, the present invention may be embodied as a method, system, or computer program product. Accordingly, the present invention may take the form of an entirely software embodiment (including firmware, resident software, microcode, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer-usable or computer-readable storage medium may be utilized. The computer-usable or computer-readable storage medium may be, for example, but is not limited to, an electronic, magnetic, optical, electromagnetic, infrared, or semiconductor system, apparatus, device, or propagation medium. More specific examples (a non-exhaustive list) of the computer-readable storage medium would include the following: a portable computer diskette, a hard disk, a random access memory (RAM), a read-only memory (ROM), an erasable programmable read-only memory (EPROM) or Flash memory, an optical fiber, a portable compact disc read-only memory (CD-ROM), an optical storage device, or a magnetic storage device. Note that the computer-usable or computer-readable storage medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable storage medium may be any medium that can contain, or store the program for use by or in connection with an instruction execution system, apparatus, or device.

A DRC runset is normally coded in a unique DRC language provided by a vendor of an underlying DRC system. This unique language is then interpreted or compiled into an object oriented programming language or a conventional procedural programming language. Computer program code for carrying out operations of the present invention may be written in an object oriented programming language, such as Java, Smalltalk, C++, etc. However, the computer program code for carrying out operations of the present invention may also be written in conventional procedural programming languages, such as the “C” programming language or similar programming languages. The program code may execute entirely on a single computer, on multiple computers that may be remote from each other, or as a stand-alone software package. When multiple computers are employed, one computer may be connected to another computer through a local area network (LAN) or a wide area network (WAN), or the connection may be for example, through the Internet using an Internet service provider (ISP).

The present invention is described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

According to various aspects of the present disclosure, techniques for improving error detection of a design rule checking (DRC) runset are disclosed herein. As noted above, traditionally, testcases for verifying that a DRC runset is operating in a desired manner have placed all shapes associated with different layers of an integrated circuit design in a same cell. Unfortunately, placing all shapes associated with different layers of an integrated circuit design in a same cell, while verifying same cell design rules, have not properly verified different cell design rules (which deal with relationships (e.g., spacing) between shapes in different cells). That is, a DRC language may treat shape-to-shape relationships differently depending on whether the shapes are in the same cell or in a different cell. For example, when a memory chip is designed, it is common to design a one-bit memory cell and replicate the one-bit cell across the memory chip. In this case, conventional approaches (which place all shapes associated with various layers of an integrated circuit design) in a single cell have not necessarily detected errors in a DRC runset that are associated with different cell shape relationships associated with different instances of the one-bit memory cells.

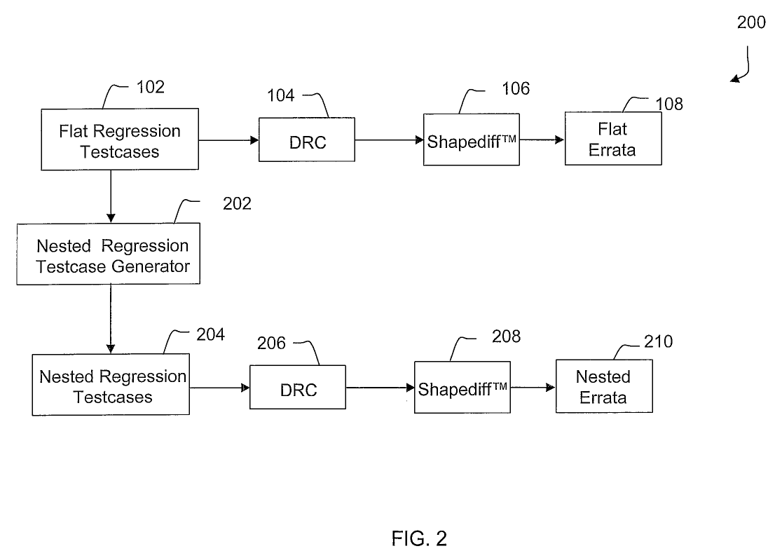

With reference to FIG. 2, a technique 200 is illustrated that employs both flat regression testcases (shapes in a single cell) and nested regression testcases (the shapes from the single cell are grouped into multiple cells based on which layer of an integrated circuit design the shapes are associated) to verify error detection of the DRC runset 104. As noted above, the flat regression testcases 102 are input to the DRC runset 104. The flat regression testcases 102 are also provided to a nested regression testcase generator 202, which outputs nested regression testcases 204, based on the testcases 102. As noted above, the testcases 102 include a number of shapes (associated with various layers of an integrated circuit design) grouped in a single cell. In contrast, the nested regression testcases 204 include the shapes (associated with various layers of the integrated circuit design) grouped into multiple cells according to which of the layers a given one of the shapes is associated.

As previously noted, an output of the DRC runset 104 is provided to the Shapediff™ program 106, which is configured to verify that the DRC runset 104 is detecting design rule errors correctly. The Shapediff™ program 106 provides output information (flat errata) 108 that can be used to modify the DRC runset 104. Similarly, the nested regression testcases 204 are provided to a replica DRC runset 206 (i.e., a copy of the DRC runset 104). The output of the replica DRC runset 206 is provided to a replica Shapediff™ program 208 (i.e., a copy of the Shapediff™ program 106), which is configured to verify that the replica DRC runset 206 is detecting design rule errors correctly. The Shapediff™ program 208 provides output information (nested errata) 210 that can also be used to modify the DRC runset 206.

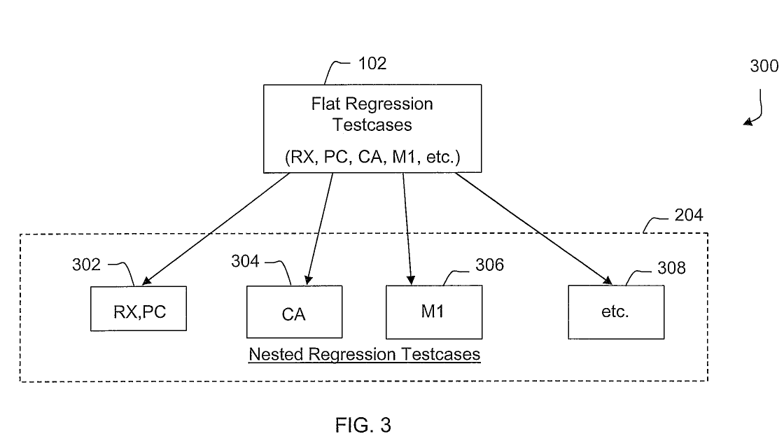

Alternatively, the flat regression testcases 102 and the nested regression testcases 204 may be sequentially provided to a single copy of the DRC runset 104 (in this case only the Shapediff™ program 106 may be implemented). As noted above, using both flat and nested errata allows errors in the DRC runset to be detected that may not have been detected using only the flat errata. Turning to FIG. 3, a diagram 300 depicts the division of the flat regression testcases 102 into the nested regression testcases 204. As is illustrated the nested regression testcases 204 include four cells 302, 304, 306, and 308, which each include shapes associated with one or more layers of an integrated circuit design. As is shown, the cell 302 includes shapes for a diffusion (RX) layer and a polysilicon (PC) layer, the cell 304 includes shapes for a contact (CA) layer, the cell 306 includes shapes for a metal 1 (M1) layer, and the cell 308 includes shapes for another layer (e.g., a metal 2 layer). While only four cells are shown in FIG. 3, it should be appreciated that more or less than four cells may be employed. Moreover, while cell 302 is shown as including shapes for two layers, it should be appreciated that, depending on the design of a DRC runset, shapes for the layers in the cell 302 may be assigned to different cells based on the layers (i.e., one cell may be used for the shapes in the diffusion layer and another cell may be used for the shapes in the polysilicon layer). In a typical implementation, a separate cell is created for nearly every layer.

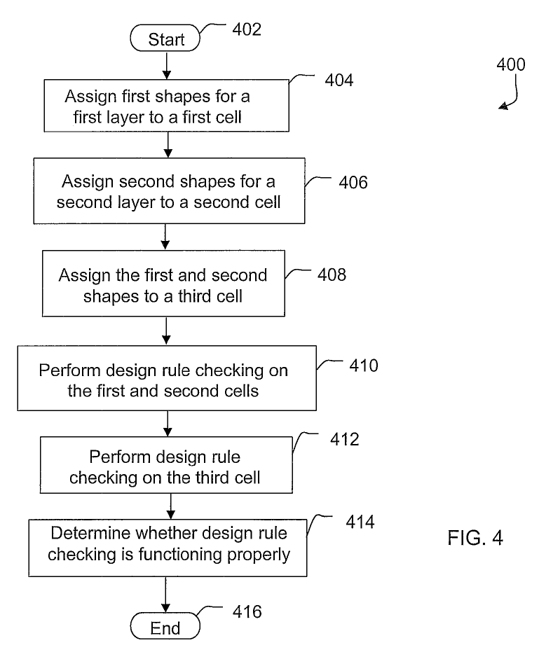

Turning to FIG. 4, a process 400 for verifying error detection of a design rule checking (DRC) runset is illustrated. In block 402 the process 400 is initiated, at which point control transfers to block 404. In block 404, first shapes for a first layer of an integrated circuit design are assigned to a first cell. Next, in block 406, second shapes for a second layer of the integrated circuit design are assigned to a second cell. In this case, the first and second cells correspond to nested regression testcases. Then, in block 408, the first and second shapes are assigned to a third cell (corresponds to flat regression testcases). Next, in block 410, design rule checking is performed on the first and second cells. Then, in block 412, design rule checking is performed on the third cell. Next, in block 414, the process 400 determines whether design rule check is properly functioning (i.e., whether testcases with intentional errors are detected and testcases without errors are not indicated to be in error).

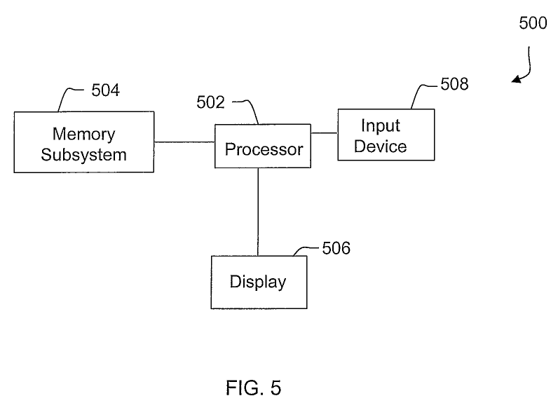

With reference to FIG. 5, an example computer system 500 is illustrated that may include one or more applications configured to verify error detection of a design rule checking runset according to various embodiments of the present disclosure. The computer system 500 includes a processor 502 that is coupled to a memory subsystem 504, a display 506, and an input device 508. The memory subsystem 504 includes an application appropriate amount of volatile memory (e.g., dynamic random access memory (DRAM)) and non-volatile memory (e.g., read-only memory (ROM)). The display 506 may be, for example, a cathode ray tube (CRT) or a liquid crystal display (LCD). The input device 508 may include, for example, a mouse and a keyboard. The processor 502 may also be coupled to one or more mass storage devices, e.g., a compact disc read-only memory (CD-ROM) drive.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A method of verifying error detection of a design rule checking runset, comprising:
assigning first shapes for a first layer of an integrated circuit design to a first cell;
assigning second shapes for a second layer of the integrated circuit design to a second cell;
performing design rule checking on the first and second cells; and
determining whether the design rule checking runset is functioning properly based on whether an error is detected in the design rule checking of the first and second cells.

2. The method of claim 1, wherein the first layer is a diffusion layer and the second layer is a polysilicon layer.

3. The method of claim 1, wherein the first layer is a contact layer and the second layer is a metal layer.

4. The method of claim 1, wherein the first layer includes a polysilicon layer that overlays a diffusion layer and the second layer is a contact layer.

5. The method of claim 1, further comprising:
assigning the first shapes to a third cell;
assigning the second shapes to the third cell;
performing design rule checking on the third cell; and
determining whether the design rule checking runset is functioning properly based on whether an error is detected in the design rule checking of the third cell.

6. The method of claim 5, wherein the first layer includes a polysilicon layer that overlays a diffusion layer, the second layer is a contact layer and the third layer is a metal layer.

7. The method of claim 1, wherein at least some of the first and second shapes correspond to actual structures of the integrated circuit.

8. The method of claim 7, wherein the first and second shapes are described in a graphics display system language provided by a layout editor.

9. A design rule checking runset encoded on a computer-readable storage medium, the design rule checking runset comprising:
first code for assigning first shapes for a first layer of an integrated circuit design to a first cell;
second code for assigning second shapes for a second layer of the integrated circuit design to a second cell;
third code for performing design rule checking on the first and second cells; and
fourth code for determining whether the design rule checking runset is functioning properly based on whether an error is detected in the design rule checking of the first and second cells.

10. The design rule checking runset of claim 9, wherein the first layer is a diffusion layer and the second layer is a polysilicon layer.

11. The design rule checking runset of claim 9, wherein the first layer is a contact layer and the second layer is a metal layer.

12. The design rule checking runset of claim 9, wherein the first layer includes a polysilicon layer that overlays a diffusion layer and the second layer is a contact layer.

13. The design rule checking runset of claim 9, further comprising:
fifth code for assigning the first shapes to a third cell;
sixth code for assigning the second shapes to the third cell;
seventh code for performing design rule checking on the third cell; and
eighth code for determining whether the design rule checking runset is functioning properly based on whether an error is detected in the design rule checking of the third cell.

14. The design rule checking runset of claim 13, wherein the first layer includes a polysilicon layer that overlays a diffusion layer, the second layer is a contact layer and the third layer is a metal layer.

15. The design rule checking runset of claim 9, wherein at least some of the first and second shapes correspond to actual structures of the integrated circuit.

16. The design rule checking runset of claim 15, wherein the first and second shapes are described in a graphics display system language provided by a layout editor.

17. A method of verifying error detection of a design rule checking runset, comprising:
assigning first shapes for a first layer of an integrated circuit design to a first cell;
assigning second shapes for a second layer of the integrated circuit design to a second cell;
assigning the first and second shapes to a third cell;
performing design rule checking on the first and second cells;
performing design rule checking on the third cell; and
determining whether the design rule checking runset is functioning properly based on whether an error is detected in the design rule checking of the first and second cells or the third cell.

18. The method of claim 17, wherein the first layer includes a polysilicon layer that overlays a diffusion layer, the second layer is a contact layer and the third layer is a metal layer.

19. The method of claim 17, wherein at least some of the first and second shapes correspond to actual structures of the integrated circuit.

20. The method of claim 19, wherein the first and second shapes are described in a graphics display system language provided by a layout editor.
